(19) United States
(12) Patent Application Publication
(10) Pub. No.: US 2023/0383901 A1
(43) Pub. Date: Nov. 30, 2023

(54) UNIVERSAL MOUNTING SYSTEM WITH PRONG-BEARING WALL ANCHORS

(71) Applicant: 3M INNOVATIVE PROPERTIES COMPANY, St. Paul, MN (US)

(72) Inventors: Joseph A. Hoffman, Minneapolis, MN (US); Mario A. Davenport, Saint Paul, MN (US); Angela L. Pan, Arden Hills, MN (US); Connor M. Pelletier-Sutton, Saint Paul, MN (US); Brian D. Gale, Blaine, MN (US)

(21) Appl. No.: 18/247,916

(22) PCT Filed: Sep. 28, 2021
(86) PCT No.: PCT/IB2021/058858

§ 371 Date: Apr. 5, 2023

Related U.S. Application Data
(60) Provisional application No. 63/088,246, filed on Oct. 6, 2020.

(51) Int. Cl. F16M 13/02

(52) U.S. Cl. CPC F16M 13/02

(57) ABSTRACT

Wall anchors and assemblies of the present disclosure include a plate, one more prongs, and a load bearing structure comprising a threaded bolt, post, or threaded bore. The prongs are typically integral with a side edge of the plate and are typically curved towards the bottom edge of the plate.

### BACKGROUND

Numerous products and devices exist for installing hooks, shelves, brackets, racks, pegboards, rods, rails, caddies, and frames on a wall. Conventional nails and screws are not always convenient solutions and may not provide sufficient support strength in the wall, particularly in the case of drywall, or other friable wallboards, which are relatively weak. Other hanging devices may avoid the use and attendant drawbacks of conventional fasteners, but nonetheless may result in excessive damage to the wallboard, require the use of conventional tools, or fail to consistently hold the desired weight.

### SUMMARY

The present inventors have devised a wall anchor construction and wall anchor assemblies that provide stronger support in load bearing directions than currently available solutions. The wall anchors and anchor assemblies may be installed without the use of tools and may be used to mount heavy weight objects like picture frames without damaging the wall or losing material fidelity. The anchors feature a base plate and one or more prongs that include a relatively high ratio of height to thickness, which can provide both an improved installation experience and more routinely successful mounting. The anchors may be used in concert to support large or heavy items for decoration, storage, or organization.

In one aspect, the present disclosure provides a wall anchor comprising: a base plate including opposing front and back surfaces, a top edge, a bottom edge and two opposing side edges; and a curved prong having a base, wherein the prong extends outwardly along an arc to a wall-penetrating outer end, and wherein the base of the prong is integral with one of the opposing side edges.

As used herein, “layer” means a single stratum that may be continuous or discontinuous over a surface.

As used herein “geometry” refers to the size and shape of an element.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

In this application, terms such as “a”, “an”, and “the” are not intended to refer to only a singular entity, but include the general class of which a specific example may be used for illustration. The terms “a”, “an”, and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and preferably by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used.

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

The disclosure will be further described with reference to the drawings, wherein corresponding reference characters indicate corresponding parts throughout the several views, and wherein:

FIG. 1 illustrates a perspective view of a wall anchor, according to one embodiment of the present disclosure;

FIG. 2 illustrates an exploded, perspective view of the wall anchor of FIG. 1 used to mount a floating shelf;

FIG. 3 illustrates a perspective view of a wall anchor according to another embodiment of the present disclosure;

FIG. 4 illustrates an exploded, perspective view of the wall anchor of FIG. 3 used to mount a shelf bracket;

FIG. 5 illustrates a perspective view of another wall anchor according to the present disclosure;

FIG. 6 illustrates a perspective view of a wall anchor according to another embodiment of the present disclosure;

FIG. 7 illustrates a perspective view of a wall anchor according to another embodiment of the present disclosure;

FIG. 8 illustrates a perspective view of a wall anchor according to another embodiment of the present disclosure;

FIG. 9 illustrates an exploded, perspective view of a wall anchor of the present disclosure used to secure a television mount to a wall;

FIG. 10 illustrates an exploded, perspective view of a wall anchor of the present disclosure used to mount an equipment hook;

FIG. 11 illustrates an exploded, perspective view of a wall anchor of the present disclosure used to mount a utility shelf;

FIG. 12 illustrates an exploded, perspective view of a wall anchor of the present disclosure used to mount a coat rack;

FIG. 13 illustrates an exploded, perspective view of the wall anchor of the present disclosure used to mount a tool grip board;

FIG. 14 illustrates an exploded, perspective view of the wall anchor of the present disclosure used to mount a single hook;

FIG. 15 illustrates an exploded, perspective view of the wall anchor of the present disclosure used to mount a caddy;

FIG. 16 illustrates an exploded, perspective view of the wall anchor of the present disclosure used to mount a bike rack;

FIG. 17 illustrates an exploded, perspective view of a wall anchor of the present disclosure used to mount a curtain rod;

FIG. 18 illustrates an exploded, perspective view of a wall anchor of the present disclosure used to hang a potted plant from a ceiling;

FIG. 19 illustrates an exploded, perspective view of the wall anchor of the present disclosure used to mount a rail and hook system for hanging items;

FIG. 20 illustrates an exploded, perspective view of the wall anchor of the present disclosure used to mount a closet organization system;

FIG. 21 illustrates an exploded, perspective view of the wall anchor of the present disclosure used to mount storage bins; and

FIG. 22 illustrates an exploded, perspective view of the wall anchors of the present disclosure used to mount a modular peg board system.

While the above-identified figures set forth several embodiments of the disclosure other embodiments are also contemplated, as noted in the description. In all cases, this disclosure presents the invention by way of representation and not limitation. It should be understood that numerous other modifications and embodiments can be devised by those skilled in the art, which fall within the scope and spirit of the principles of the invention.

### DETAILED DESCRIPTION OF ILLUSTRATIVE EMBODIMENTS

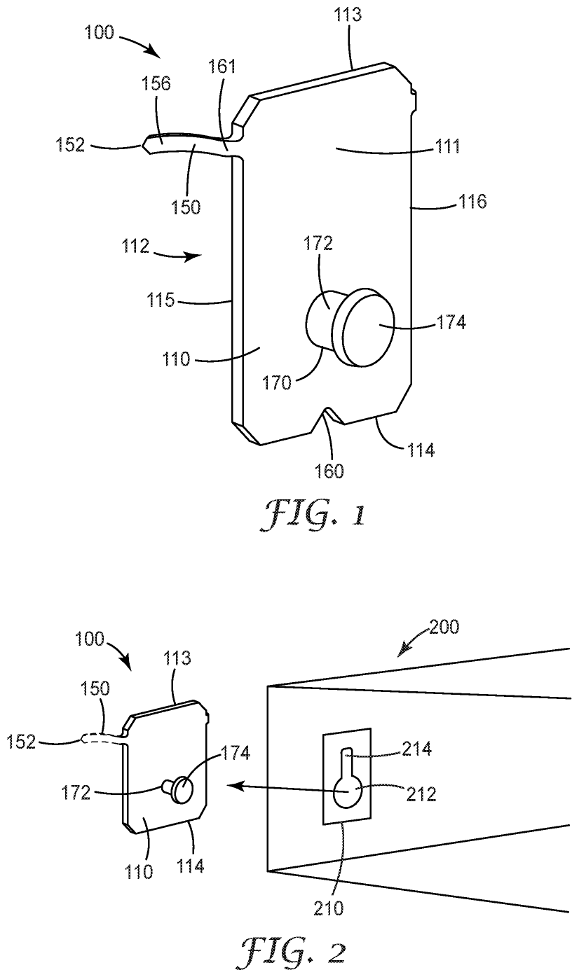

A wall anchor 100 according to one embodiment of the present disclosure is depicted in FIGS. 1 and 2. The wall anchor 100 includes a base plate 110 presenting generally rectangular shape. The base plate 110 includes a front surface 111 opposing a back, wall-facing surface 112, a top edge 113, a bottom edge 114, and opposing side edges 115, 116 connecting the top and bottom edges 113, 114 to define an outer plate perimeter. A pair of downwardly curved prongs 150 extend from each side edge 115, 116 in a direction generally orthogonal to the back surface 112. The prongs 150 extend to an outer end 152 that can be tapered to ease insertion when pressed into wall board or another penetrable surface.

The base plate 110 has an overall, generally rectangular shape when viewed in a plane perpendicular to the base plate plane “P”. In other embodiments, the base plate 110 present another shape or combination of shapes in the same viewing direction, including circular, ovular, triangular tetrahedral, Y-shaped, etc. Other variations are contemplated and discernable by those of skill in the art.

The base plate 110 includes an alignment notch 160 adjacent the bottom edge 114. The alignment notch 160 can also provide visual confirmation of the anchor 100 placement and orientation on a wall surface, as well as presenting a location at which a user may mark the wall surface for subsequent placement of the anchor. The alignment notch 160 may be triangular as depicted to direct the stylus of a pen or other marking instrument to the desired location and may be sized and shaped to ensure a visible marking can be made on the surface. In other embodiments, the notch may be arcuate, rectangular, or other cognizable shape designed to communicate placement and accept the tip of a marking instrument. Other embodiments not depicted can feature an alignment notch of some or all of the other edges 114, 115, and 116.

The pair of curved prongs 150 are proximate the top edge 113. The prongs 150 each extend to an outer end 152 over a length that is generally equal to or less than the thickness of the wallboard to which the anchor would typically be attached. The lengths of one or both of the prongs 150 can be varied to allow selection for a specific thickness of wallboard. The curved prong 150 can have a fixed radius of curvature, or have varying radii of curvature at various points, either discretely or continuous, along the outer profile of the prong 150 from the base 151 to the outer end 152. The curvature produces a tip distance from the top edge of the prong base 151 to a plane parallel to the outer end 152, with greater curvature producing a greater tip distance. While not wishing to be bound by theory or relation solely to gypsum wallboard, it is believed that an increase in tip distance leads to an increase in the weight that may be mounted on the anchor 100. In one exemplary embodiment, the tip distance is about 0.15 inches. In depicted implementations, the prongs 150 are downwardly curved, in that the end 152 is closer than the bottom edge 151b to a plane including the bottom edge 114 of the base plate 110. In other circumstances, one or more prongs may include an upward curve, in that the end 152 is closer than the top edge to a plane including the top edge 113 of the base plate 110.

The prongs 150 may include one or more flat surfaces and may comprise different cross-sectional shapes and combination of shapes (e.g., rectangular, circular, ovular, triangular etc.). For instance, an upper surface of a prong may be rounded, with a planar bottom surface to prevent crack propagation in the wallboard. The flat surface can also aid in the prevention of pullout due to stress concentrations on the wallboard. In the embodiment depicted, each prong 150 includes opposing, substantially planar side surfaces, each side surface extending in a plane generally orthogonal to the base plane “P”. In other implementations, one or both edges of the prong may be serrated.

Each of the prongs 150 include a height and a thickness at the base 151. The thickness is measured in a direction parallel to the top edge 113 (e.g., the x-direction) and corresponds to the distance between prong side surfaces 156. A comparison of height 155 to thickness defines a prong aspect ratio. In presently preferred implementations, the aspect ratio is at least 1.5:1, at least 2:1; at least 3:1. In one exemplary embodiment, the height can be about 0.10 inches and the thickness can be about 0.022 inches, resulting in a prong aspect ratio of 4.55:1. In other exemplary embodiments, the height 155 can be about 100 mils, and the thickness can be about 50 mils, resulting in an aspect ratio closer to 2:1. Typically the prong aspect ratio is no greater than about 5:1, and in other embodiments no greater than about 4:1. As further described below, the relatively thin nature of the prongs 150 reduces the needed insertion force, while the wallboard itself serves to prevent the buckling of the prong 150 as it is inserted. Relying on the wall to prevent buckling allows for the anchor to hold progressively heavier objects. The curved prongs 150 can taper in height over all or a portion of the arc length from base 151 to end 152 or can have a generally uniform height over the length as depicted.

Without wishing to be bound by theory, the prong aspect ratio can change the failure mode of the anchor by enhancing the strength of the prong in load-bearing directions (e.g., towards the bottom edge 114). The enhanced strength acts against the bending on the prong while the mounting of progressively heavier objects, such bending otherwise potentially resulting in the destruction of the wallboard before the prong yields. A relatively high aspect ratio prong can accordingly perform to user expectations for more typical mounting hardware (e.g., nails, screws, etc.) while still reducing the work needed to install.

In the illustrated embodiment, and as can be seen particularly clearly from FIG. 1, the prongs 150 can be formed from a monolithic piece of material that has been bent or otherwise articulated at select locations to form both base plate 110 and prongs 150. Thus, each of the prongs 150 includes at least one section that is integral and substantially coplanar with a side edge 115, 116. In other embodiments, one or more of the prongs may be soldered, welded, or otherwise attached to the back surface 112 of the frame 110 at an edge 115, 116. Any of the prongs 150 may be previously articulated when provided to a user, or the user may opt to bend each of the wall-penetrating components to the user's liking.

In the depicted embodiment, both the prongs 150 extend to coplanar endpoints and prongs 150 each include the same radius of curvature. In alternative embodiments, either of the prongs 150 may be offset from the other along the length of the respective edge 115, 116, such that one prong base 151 is nearer to the top edge 113 than the other. Furthermore, the base plate 110 may include one or more prongs in addition to the depicted pair of prongs 150; such additional prong(s) may feature the same or different radius of curvature, prong aspect ratio, outer end plane, length, or position alongside a side edge 115, 116 or back surface 112 of the base plate 110. The additional prongs may increase the weight hanging capabilities of the anchor but may result in additional damage to a wall surface on installation. Moreover, the plurality of insertion points provided by multiple prongs can improve the stability of an anchor during installation, use, and removal.

A load bearing projection 170 extends outward from the front surface 111 of the base plate 110 and is aligned with the central longitudinal axis of the anchor 100. The load bearing projection 170 as depicted is a cylindrical post 172 with a terminal flange 174 having a circumference greater than the circumference of the post 172. The post 172 and flange 174 can be dimensioned for receipt in a key-hole or other common aperture of a frame, shelf, bracket, rod, or any other item to be mounted. The flange 174 tends to prevent the mounted item from tipping or otherwise falling off the load bearing projection 170. Though depicted as a cylindrical, the post 172 may comprise different cross-sectional shapes and combination of shapes (e.g., rectangular, ovular, triangular, trapezoidal, etc.). Likewise, the flange 174 may likewise include different cross-sectional shapes and combination of shapes; the cross-sectional shape of the post 172 and the flange 174 may be the same or different.

Though not depicted, an anchor 100 may include two or more load bearing structures aligned along a longitudinal axis, a latitudinal axis, or both. As can be seen in FIG. 1, the first projection 170 is disposed on the front face 111 below the bottom edge of the prong base 151 and nearer the alignment notch. It should be appreciated, however, that the projection 170 may be placed at any desired location on the front face 111, though such placements may reduce the shear holding capacity of the anchor and limit the type of objects that may be mounted thereon.

In other embodiments (not depicted) the load bearing structure may extend from a top, bottom edge, or side edge(s) of the base plate 110. The load bearing structure may be one or more of a tab, flange, hook, or ledge, among other implements. In one such embodiment, the load bearing structure includes a pair of flanges or tabs on opposing sides edges of base plate 110. The flanges may be oriented at an oblique angle relative to the front surface of the base plate and may be received in corresponding channels or the like on the mounting item. The flanges can also include flexible tabs to aid in retention of the mounting item on the wall anchor, such that the movement of the mounting item onto the wall anchor causes an initial displacement of the flexible tab. Once the mounting item is seated at the desired or prescribed location on the wall anchor, the flexible tab may revert (e.g., snap back) into its initial position, creating a retention force on the mounting item.

Referring to FIG. 2, one method for attaching the mounting item to a wall anchor is illustrated. In a first step, the lower edge 114 of the wall anchor is positioned at the desired location of the wall, optionally using the alignment groove 160. The anchor 100 is rotated about the bottom edge so that the outer end 152 of each curved prong 150 extends horizontally toward the wall, with the outer point 152 at a desired entry point. Force is applied in direction orthogonal to the front face 111 of the lower section 120, preferably at a location on the front face 111 adjacent each of the curved prongs 150. The orthogonal force applied results in the anchor rotating about the lower edge 114 and the outer end 152 of the prongs 150 penetrating the wallboard. Further rotation results in the remaining length of the prong being driven into the wallboard until the back surface 112 of the base plate 110 is generally flush with the wall.

An object 200 (here in FIG. 2, a portion of shelf) may be secured to the load bearing projection 170 before or after, though typically after, the anchor 100 has been inserted into the wall. The shelf 200 includes a key-hole hanger 210 as a mounting implement, featuring a placement aperture 212 and a slot 214. The slot 214 has a width less than the diameter of the aperture 212. The flange 174 has a diameter less than the diameter of the aperture 212 but greater than the thickness of the slot 214. In concert, the post 172 also has a diameter less than or equal to the width of the slot 214. Such a geometrical distribution of elements allows the flange 174 received in and through the aperture 212 so that the post 172 can traverse through the slot 214 in a direction towards the top of the shelf 200 until it reaches the arcuate end 215. The flange 174, having a greater diameter than the slot 214, will reduce or prevent tipping and further movement of the object 200 relative to the anchor 100.

Key-hole hangers or other mounting apertures are typically dimensioned and positioned to receive a nail, screw, or other fastener to aid in securing the object to a wall. One or multiple anchors 100 of the present disclosure may replace these common fasteners, with each mounting aperture accommodating a post 172; generally but exclusively, the number of anchors 100 used corresponds to the number of mounting apertures available on the object 200.

For removal, the object 200 may be pulled upward, causing the post 172 to travel through the slot 214 back towards the placement aperture 212. Once the flange 174 is aligned with the placement aperture 212, the object 200 can then pulled away from the wall to decouple the anchor 100 and the eyelet 210. To remove the anchor itself, the base plate may be pulled downwards and outwards by adjacent the top edge 113. The lower edge 114 naturally pivots upon itself and the anchor is dislodged as the outer ends 152 of the prongs 150 exit the wall. The upper section 120 may feature structures at the upper edge 113 to assist removal, such as a boss that can be engaged with a screwdriver, key or other implement, or a tab that may be engaged by a human finger.

In some embodiments, the flange 174 may be separable from the post 172, allowing the flange 174 to act as a cap. The separable flange 174 or cap may be secured to the post 174 after it has been received in an appropriately sized aperture on the mounting implement.

In presently preferred implementations, the anchor 100 is made of a metal containing material, however, it can be appreciated that other suitable materials can be used. The anchor 100 is typically made from a resilient metal or metal alloy, such as stainless steel, titanium, cobalt-chromium alloy (such as manufactured by Elgiloy Specialty Metals, Elgin, IL), or a shape-memory alloy such as an alloy of nickel and titanium (e.g., Nitinol). Preferably, the anchor 100 is sufficiently resilient so that the shape when relaxed does not significantly change during the course of mounting an object. As another option, the anchor 100 could be made from any other resilient material known to one skilled in the art, such as a flexible polymer or composite material. Moreover, although the anchor 100 is specifically discussed as mountable on a wall of gypsum wallboard, it can be utilized with walls of other materials or to secure an object to something other than a wall.

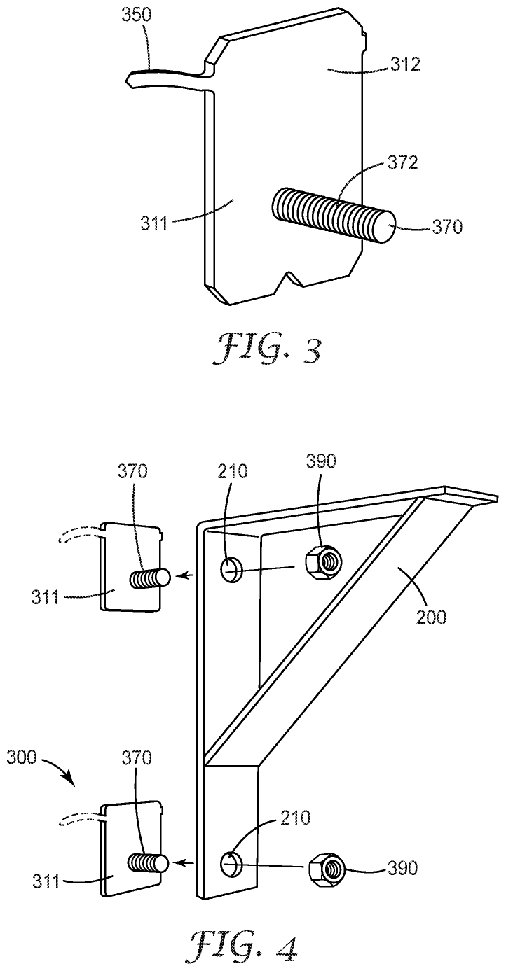

Turning to FIGS. 3 and 4, another embodiment of a wall anchor 300 according to the present disclosure is depicted. Like anchor 100, the wall anchor 300 includes a base plate 310 including a front surface 311 opposing a back, wall-facing surface 312. A pair of downwardly curved prongs 350 extend from each side edge 315, 316 in direction generally orthogonal to the back surface 312. It is to be understood that many other aspects of anchor 300 may have similar form and function to those described with respect to anchor 100 and these need not be repeated.

The load bearing projection 370 is a threaded bolt extending outward from and generally orthogonal to the front surface 311 of the base plate 310. The threads 372 may have any desired spacing or thickness, while the bolt may have any desired geometry. Typically, the bolt geometry and thread spacing are selected to accept or interact with commonly used nuts and washers. As shown in FIG. 4, the threaded bolt may be received in a mounting aperture 210 on an object to be mounted (here, a shelf bracket 200). Such mounting apertures 210 are typically dimensioned and positioned to receive a nail, screw, or other fastener to aid in securing the object to the wall. Multiple anchors 300 of the present disclosure may replace these common fasteners, with each mounting aperture 210 receiving a threaded bolt; generally, the number of anchors 300 used corresponds to the number of mounting apertures available on the object 200. A nut 390 having a corresponding threading may then be rotated along the length of the bolt 370 until a surface of the object 200 including the aperture 210 is adjacent or secured against the front surface 311 of the anchor.

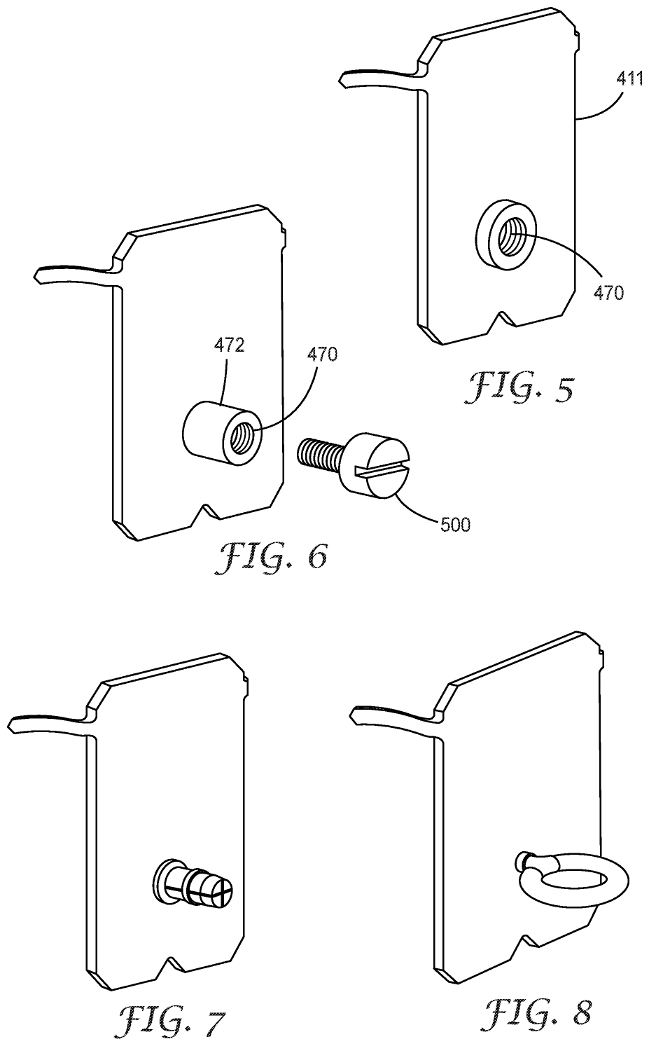

Alternatively, the anchors of the present disclosure may be adapted to accept a screw or bolt. As seen in FIGS. 5 and 6, the load bearing projection may be replaced by a threaded bore 470. The bore 470 may be open to the back surface of the anchor (FIG. 5) or may terminate on the front surface (FIG. 6). An appropriately sized screw or bolt can be received through a mounting aperture 210 on an object to be mounted 200 and screwed into the threaded bore 470 in lieu or in addition to the mounting surface material. The bore 470 may be generally flush with the front face 411 (FIG. 5) or may be made through a length of post 472 extending orthogonal to the front face 411 (FIG. 6). The post 472 length can be commensurate with a length of a cooperating/corresponding screw or bolt 500.

Other alternative load bearing projections for anchors of the present disclosure include a snap-fit connector (FIG. 7) and an eyelet (FIG. 8),

The wall anchors and assemblies of the present disclosure can be used even in instances where the object does not include a key-hole hanger or apertured mounting implement but instead includes a different backing hardware configuration or mounting implement. Exemplary backing hardware configurations include, but are not limited to, a wire, a “D”-ring, a saw-tooth hanger, etc.

The wall anchors of the present disclosure may be used in concert and in combination to mount myriad items and objects to surfaces such as painted drywall, plaster, concrete, glass, ceramic, fiberglass, metal or plastic. Items that can be mounted include, but are not limited to, wall hangings, organizers, holders, baskets, containers, decorations (e.g., holiday decorations), calendars, posters, dispensers, wire clips, guitars, floating shelves, curtain rods, heavy-duty hooks, brackets, wall sconces, and carrying handles.

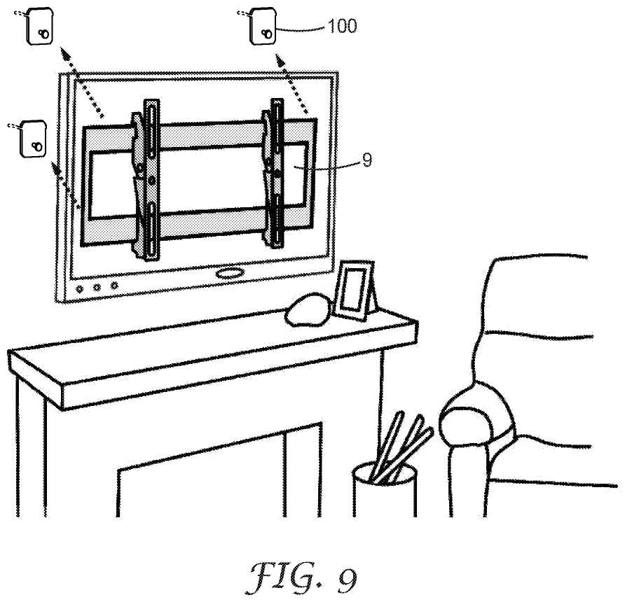

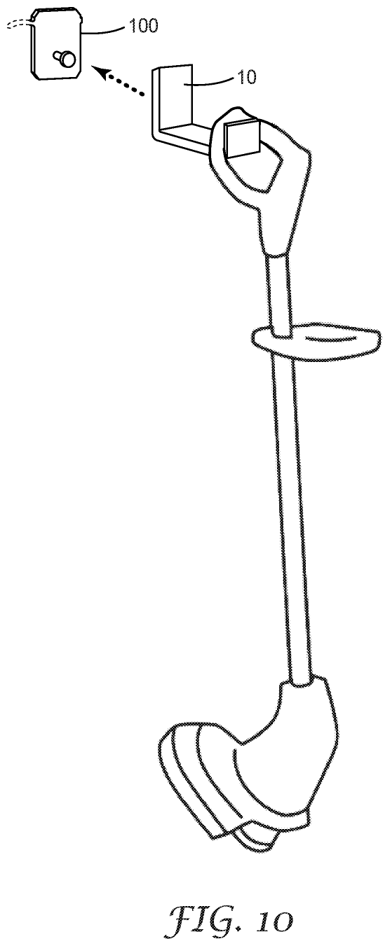

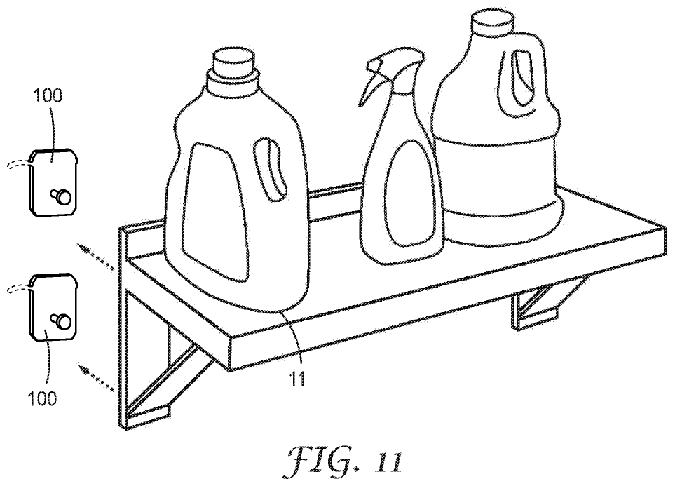

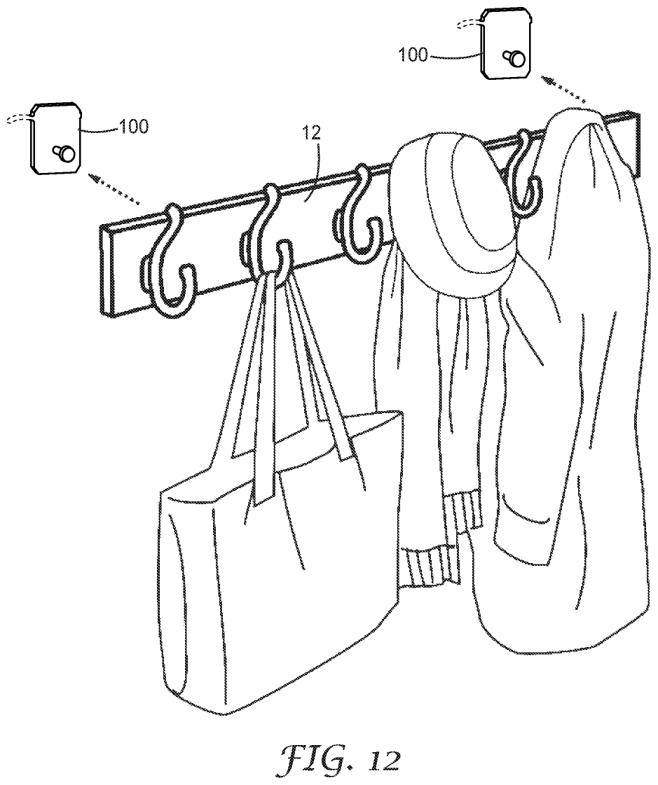

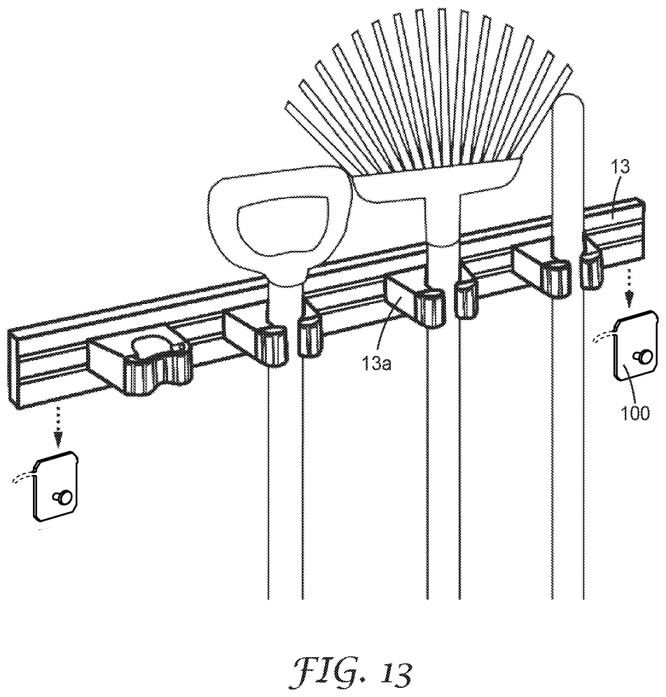

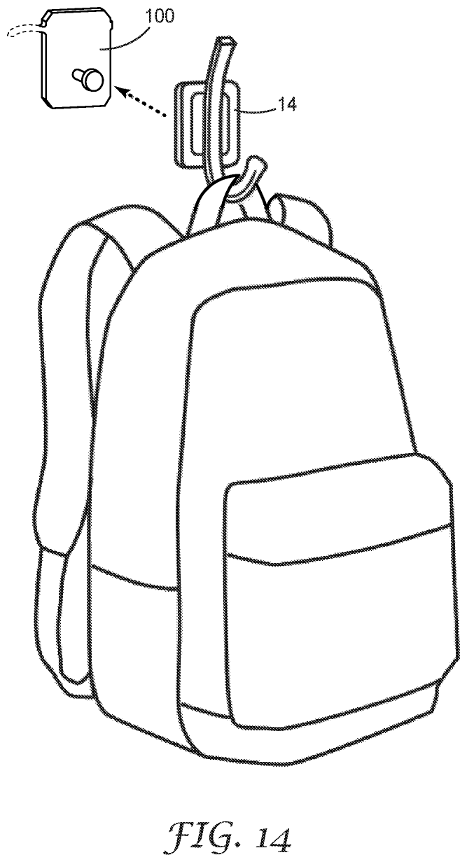

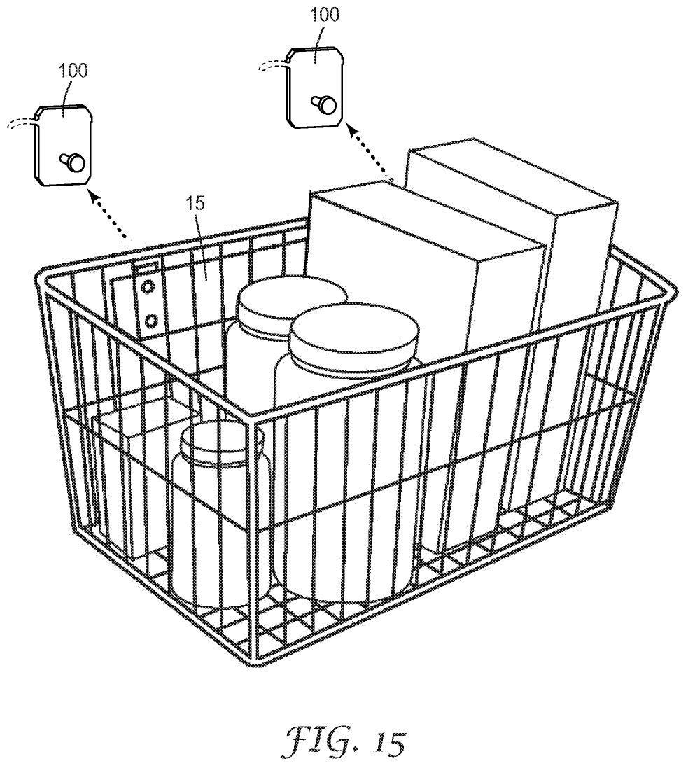

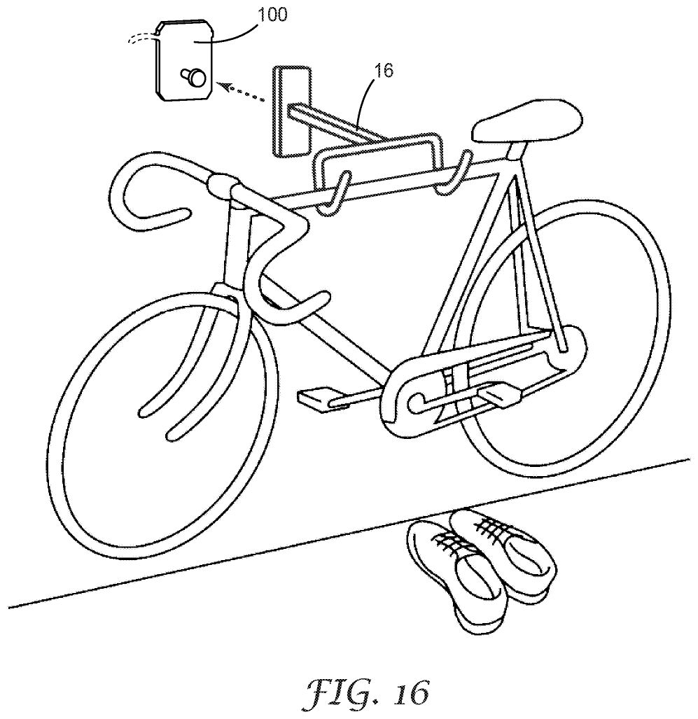

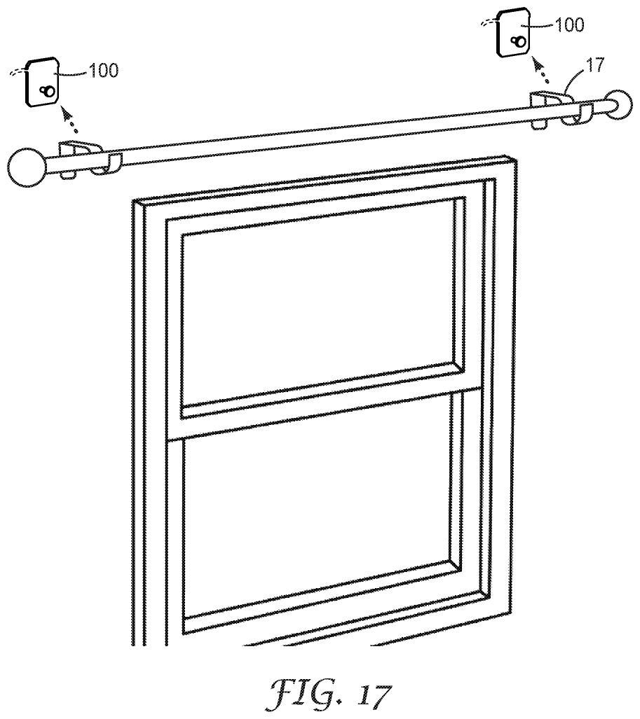

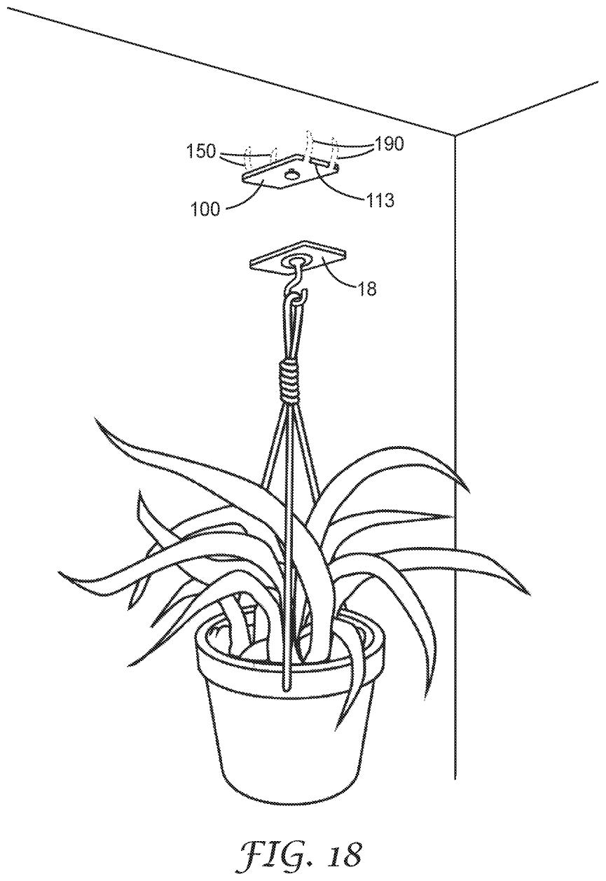

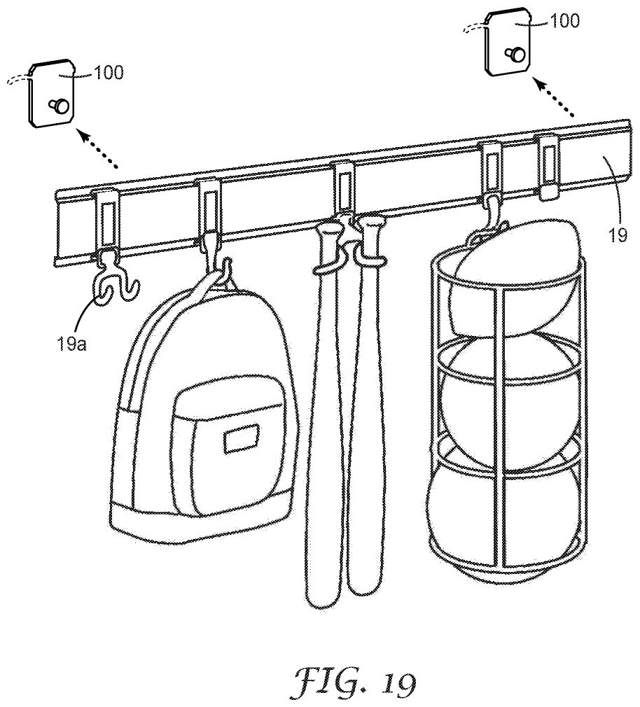

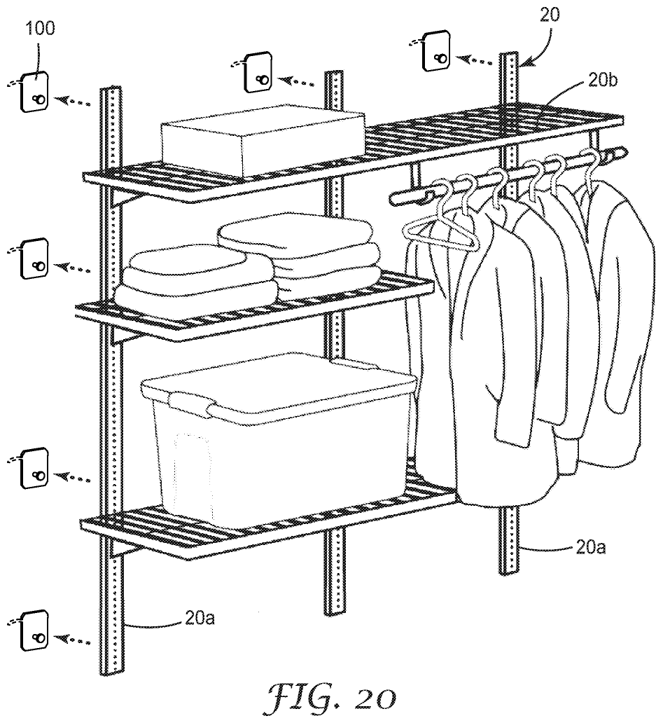

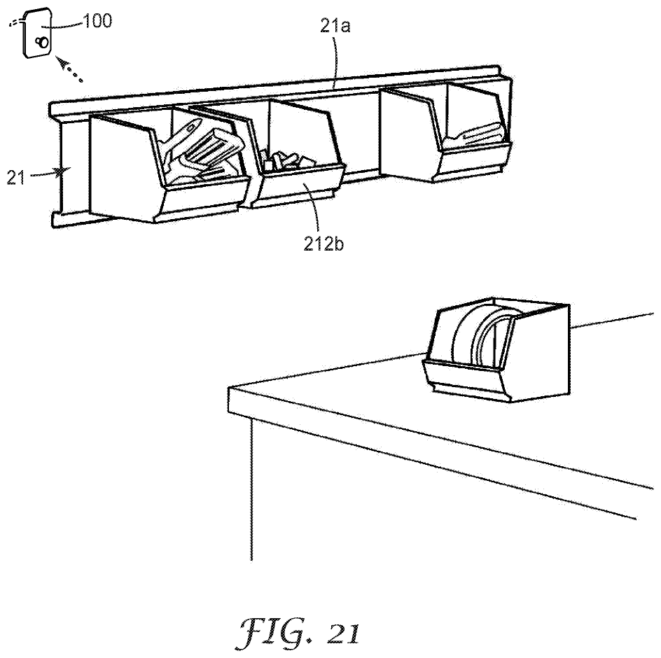

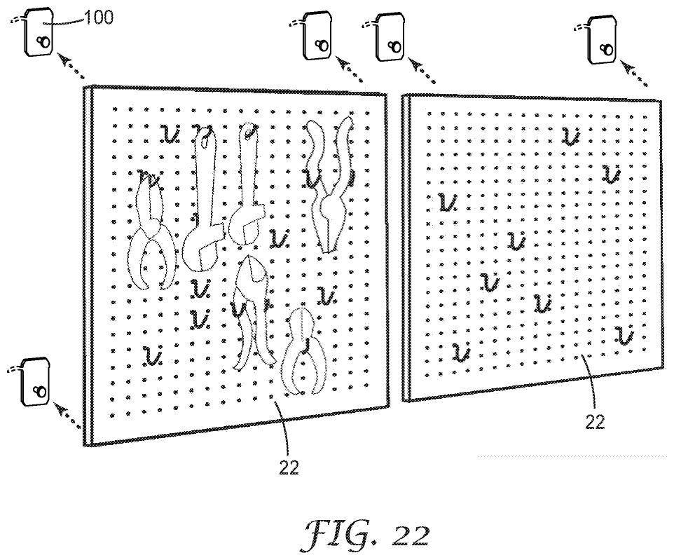

FIGS. 9-22 depict anchors of the present disclosure used mount several household objects. The wall anchor(s) 100 is the only anchor depicted in these exemplary systems, but any anchor embodiment described in the present application may be used in lieu of or in addition to wall anchor(s) 100. As one example, three of more anchors 100 may be used to hang an articulatable or rotatable television mount 9 (FIG. 9). As another example, a wall anchor 100 may be used to support an equipment hook 10 having a flat surface useful for suspending landscaping or other tools (FIG. 10). As another example, four or more wall anchors 100 (two of which are shown) may be used to mount the brackets of a utility shelf 11 (FIG. 11). As another example, two or more wall anchors 100 may be used to mount a coat rack 12 (FIG. 12). As another example, two or more wall anchors 100 may be used to mount a rack 13 having multiple handle grippers 13a useful for grabbing landscaping tools or sports equipment (FIG. 13). As another example, a wall anchor 100 may be used to support semi-decorative hook 14 useful for suspending bags, purses, or coats (FIG. 14). As another example, two or more anchors 100 may be used to support a bath or kitchen caddy, potentially in the form of a wire basket 15 designed to hold cleaning or bathing supplies (FIG. 15). As another example, a wall anchor 100 may be used to support a bike rack 16 spaced from a mounting plate by a post and including a plurality of hooks (FIG. 16). As another example, two or more wall anchors 100 may be used to support holders 17 for hanging a curtain rod (FIG. 17). As another example, a wall anchor 100 may be secured to the ceiling and coupled to a hook plate 18 useful for hanging a potted plant (FIG. 18). A second pair of upwardly curved prongs 190 (i.e., curved towards the base of downwardly curved prongs 150) at or adjacent the bottom edge 113 may be desirable for securing the anchor to a horizontal surface. As another example, two or more wall anchors 100 may be used to mount a rack 19 having multiple hooks 19a useful for hanging bags, tools, or sports equipment (FIG. 19). As another example, a plurality of wall anchors 100 may be used to mount a shelving system 20 including a plurality of rails 20a and adjustable wire shelves 20b (FIG. 20). As another example, two or more wall anchors 100 may be used to mount a rack 21 having rails useful for hanging storage bins 21a (FIG. 21). As another example, a plurality of wall anchors 100 may be used to mount a multiple, modular sections of pegboard 22 (FIG. 22).

The patents, patent documents, and patent applications cited herein are incorporated by reference in their entirety as if each were individually incorporated by reference. It will be apparent to those of ordinary skill in the art that various changes and modifications may be made without deviating from the inventing concepts set from above. Thus, the scope of the present disclosure should not be limited to the structures described herein. Those having skill in the art will appreciate that many changes may be made to the details of the above-described embodiments and implementations without departing from the underlying principles thereof. Further, various modifications and alterations of the present invention will become apparent to those skilled in the art without departing from the spirit and scope of the invention. The scope of the present application should, therefore, be determined only by the following embodiments and equivalents thereof.

We claim:

1. A wall anchor comprising:
a base plate including opposing front and back surfaces, a top edge, a bottom edge and two opposing side edges;
a downwardly curved prong having a base, wherein the prong extends outwardly along an arc to a wall-penetrating outer end,
a load bearing structure adjacent the bottom edge, the load bearing structure comprising one of a post, a threaded bolt, and a threaded bore,
wherein the base of the prong is integral with one of the opposing side edges.

2. An object mounting system comprising the wall anchor of claim 1 and a mounting object, wherein the object includes an aperture dimensioned to receive the load bearing structure.

3. The object mounting system of claim 2, wherein the mounting object includes a key-hole hanger including the aperture and a slot.

4. The object mounting system of claim 3, wherein the load bearing structure comprising a post and a flange, and wherein the post is configured to be received in the slot.

5. The object mounting system of claim 4, wherein the flange has a diameter greater than the width of the slot.

6. A ceiling anchor comprising:
a base plate including opposing front and back surfaces, a top edge, a bottom edge and two opposing side edges;
a first pair of curved prongs each having a base, wherein each prong of the first pair extends outwardly along an arc to a wall-penetrating outer end,
a second pair of curved prongs each having a base, wherein each prong of the second pair extends outwardly along an arc to a wall-penetrating outer end,
a load bearing structure adjacent the bottom edge, the load bearing structure comprising one of a post, a threaded bolt, and a threaded bore,
wherein the base of each curved prong is integral with one of the opposing edges.

7. The ceiling anchor of claim 6, wherein the anchor further comprising a hook plate configured for coupling to the load bearing structure, the hook plate including a hook configured to hang an item.
